(19) United States
(12) Patent Application Publication
(10) Pub. No.: US 2020/0001990 A1
(43) Pub. Date: Jan. 2, 2020

(54) AUTOMATICALLY AND RELEASABLY COUPLING UAV PROPELLERS TO PROPULSION MOTORS, AND ASSOCIATED SYSTEMS AND METHODS

(71) Applicant: SZ DJI TECHNOLOGY CO., LTD., Shenzhen (CN)

(72) Inventors: Bin JIANG, Shenzhen (CN); Guannan REN, Shenzhen (CN)

(21) Appl. No.: 16/566,568

(22) Filed: Sep. 10, 2019

Related U.S. Application Data
(63) Continuation of application No. PCT/CN2017/076696, filed on Mar. 15, 2017.

(51) Int. Cl. B64C 27/32; B64C 39/02; B64D 35/04

(52) U.S. Cl. CPC B64C 27/32; B64C 39/024; B64D 35/04; B64C 2201/027; B64C 2201/165; B64C 2201/108; B64C 2201/146

(57) ABSTRACT

A propulsion system for an unmanned aerial vehicle (UAV) includes a propulsion motor configured to drive a propeller and an apparatus configured to releasably couple the propeller to the propulsion motor. The apparatus includes an engagement member, at least a portion of which is positioned to move relative to the propulsion motor and/or the propeller along a rotational axis of the propulsion motor between an engaged position and a disengaged position different from the engaged position. When in the disengaged position, the engagement member couples the propeller to the propulsion motor.

### CROSS-REFERENCE TO RELATED APPLICATION

This application is a continuation of International Application No. PCT/CN2017/076696, filed Mar. 15, 2017, the entire content of which is incorporated herein by reference.

### TECHNICAL FIELD

The present disclosure is directed generally to automatically and releasably coupling UAV propellers to propulsion motors, and associated systems and methods.

### BACKGROUND

Unmanned aerial vehicles (UAVs) may have one or more rotary blades or rotors (for example, propellers) coupled to one or more corresponding propulsion motors. Existing propulsion systems and propeller structures require a user to hold a propeller against a propulsion motor assembly while securing the propeller to the propulsion motor. For example, traditional propeller structures require a user to twist the propeller to thread the propeller onto a corresponding threaded portion of the propulsion motor. But such traditional modes of assembly may allow a propeller to come loose prior to or during flight without any indication or notification to the user. As UAV safety requirements become more demanding, traditional ways to couple a propeller to a propulsion motor may not meet such safety requirements. And as UAV users become more sophisticated, such users may demand easier systems and methods to couple propellers to corresponding propulsion motors. Accordingly, there remains a need for improved mechanisms, techniques, and systems for releasably coupling UAV propellers to propulsion motors.

### SUMMARY

The following summary is provided for the convenience of the reader and identifies several representative embodiments of the disclosed technology. Such representative embodiments are examples only and do not constitute the full scope of the disclosure.

Representative embodiments of the present technology include a propulsion system for an unmanned aerial vehicle (UAV). The propulsion system can include a propulsion motor configured to drive a propeller, and an apparatus for releasably coupling the propeller to the propulsion motor. The apparatus can include an engagement member. In such representative embodiments, at least a portion of the engagement member is positioned to move relative to the propulsion motor and the propeller along a rotational axis of the propulsion motor between an engaged position in which the engagement member couples the propeller to the propulsion motor and a disengaged position different from the engaged position.

In particular representative embodiments, a driving mechanism, such as a motor, can be operatively connected to the engagement member to cause the portion of the engagement member to move between the engaged position and the disengaged position. The engagement member can include a hook element pivotably connected to the propulsion motor. The hook element can be positioned to be received in a recess in a hub portion of the propeller when the engagement member is in the engaged position and disengaged from the recess when the engagement member is in the disengaged position. The driving mechanism can be configured to move the engagement member, optionally via one or more transmission links.

In particular representative embodiments, the portion of the engagement member can be a disk element carried by an elongated rod element and having one or more flange elements positioned to engage one or more corresponding recesses in a propeller when the disk element is in the engaged position. Such an elongated rod element can be positioned to move along the rotational axis of the motor and to rotate about the rotational axis to cause the disk element to move and rotate between the engaged position and the disengaged position. When the disk element is in the disengaged position, the one or more flange elements are disengaged from the recesses.

In particular representative embodiments, a sensor assembly (such as a touch switch or infrared emitter-detector pair) can be positioned to sense whether a portion of an engagement member is in the engaged position. A controller can be programmed with instructions that, when executed, receive a signal from the sensor assembly indicating whether the portion of the engagement member is in the engaged position and transmit a status of the propulsion system corresponding to the signal.

In another representative embodiment of the present technology, a propulsion system for an unmanned aerial vehicle (UAV) includes a propeller configured to be driven by a propulsion motor. The propeller can include at least one blade element attached to a hub portion. In such a representative embodiment, the hub portion includes an interior opening configured to receive an engagement member of a releasable coupling mechanism. In such a representative embodiment, the hub portion also includes at least one recessed portion associated with the opening and configured to engage the engagement member.

In another representative embodiment of the present technology, a propeller for an unmanned aerial vehicle (UAV) includes a hub portion configured to couple with a propulsion motor and at least one blade element extending radially from the hub portion. The hub portion can include an interior opening configured to receive an engagement member of a releasable coupling mechanism. The hub portion can include at least one recessed portion associated with the opening and configured to engage the engagement member.

In another representative embodiment of the present technology, an unmanned aerial vehicle (UAV) includes an airframe and one or more propulsion systems according to representative propulsion systems of the presently disclosed technology. In such embodiments, a propulsion motor is coupled to an airframe and an engagement member is carried by the airframe.

In another representative embodiment of the present technology, a kit for assembling an unmanned aerial vehicle (UAV) includes (a) an airframe; (b) one or more propulsion motors; (c) one or more propellers; (d) a plurality of releasable coupling mechanism components including an engagement member configured to be coupled to the UAV; and (e) instructions comprising information to assemble the plurality of releasable coupling mechanism components. When such a UAV according to a representative embodiment is assembled, the assembled UAV includes the engagement member carried by the airframe. In such a representative embodiment, at least a portion of the engagement member is positioned to move relative to the propulsion motor and the propeller along a rotational axis of the motor between an engaged position in which the engagement member couples the propeller to the motor and a disengaged position different from the engaged position.

In another representative embodiment of the present technology, a method of coupling a propeller to an unmanned aerial vehicle (UAV) includes providing one or more propellers and an airframe carrying one or more propulsion motors. Such a representative method includes coupling the multiple propellers to corresponding propulsion motors, carried by an airframe, via corresponding releasable coupling mechanisms carried by the airframe. In such a representative embodiment, individual releasable coupling mechanisms include an engagement member. In such a representative embodiment, at least a portion of the engagement member is positioned to move relative to the corresponding propulsion motor and propeller along a rotational axis of the corresponding propulsion motor between an engaged position in which the engagement member couples the propeller to the corresponding propulsion motor, and a disengaged position different from the engaged position.

In another representative embodiment of the present technology, an unmanned aerial vehicle (UAV) control system includes a controller and a computer-readable medium carried by the controller and programmed with instructions that, when executed, receive a request to operate a releasable coupling system. Such a releasable coupling system can be configured to couple a propeller to a propulsion motor and to release a propeller from the propulsion motor. In response to such a request, the instructions, when executed, can direct the releasable coupling system to couple the propeller to the propulsion motor or to release the propeller from the propulsion motor.

In another representative embodiment of the present technology, a controller-implemented method for operating an unmanned aerial vehicle (UAV) includes receiving a request to move an engagement member between an engaged position in which at least a portion of the engagement member is positioned to couple a propeller to a propulsion motor and a disengaged position different from the engaged position, and in response to the request, directing a releasable coupling system to move the engagement member between the engaged position and the disengaged position.

Advantages of embodiments of the present technology include an improved manner of connecting and removing propellers from propulsion motors in UAVs. For example, releasable coupling mechanisms in accordance with embodiments of the present technology can provide automatic or streamlined installation or coupling of propellers to propulsion motors. The security of a mechanical connection between propulsion motors and propellers is also improved by releasable coupling mechanisms and systems according to embodiments of the present technology.

### BRIEF DESCRIPTION OF THE DRAWINGS

FIG. 1 is a partially schematic, isometric illustration of a UAV having an airframe and a releasable coupling system in accordance with representative embodiments of the present technology.

FIG. 2 is a partially schematic, isometric illustration of at least a portion of the airframe shown in FIG. 1, including a releasable coupling mechanism in accordance with a representative embodiment of the present technology.

FIG. 3 is a partially schematic, isometric illustration of the releasable coupling mechanism shown in FIG. 2, in a disengaged configuration.

FIG. 4 is a partially schematic, isometric illustration of the releasable coupling mechanism shown in FIG. 2, in an engaged configuration.

FIG. 5 is a partially schematic, cross-sectional illustration of at least a portion of the airframe shown in FIGS. 1-3 in which several elements of the releasable coupling mechanism are shown.

FIG. 6 is a partially schematic, cross-sectional illustration of the portion of the airframe shown in FIG. 5 in which the releasable coupling mechanism is in an engaged configuration.

FIG. 7 illustrates a partially schematic bottom view of at least a portion of the airframe shown in FIGS. 1 and 2 in accordance with a representative embodiment of the present technology, in which the releasable coupling mechanism is in the disengaged configuration.

FIG. 8 illustrates a partially schematic bottom view of the portion of the airframe shown in FIG. 7, in a configuration in which the releasable coupling mechanism is in the engaged configuration.

FIG. 9 illustrates a partially schematic, cross-sectional view of another representative embodiment of a driving mechanism for operating a releasable coupling mechanism.

FIG. 10 illustrates a partially schematic, cross-sectional view of an outer portion (such as an arm) of an airframe for a UAV having a releasable coupling mechanism in accordance with another representative embodiment of the present technology, in a disengaged configuration.

FIG. 11 illustrates a partially schematic, cross-sectional view of the outer portion with the releasable coupling mechanism shown in FIG. 10 in the engaged configuration.

FIG. 12 illustrates a partially schematic, cross-sectional view of the outer portion with the releasable coupling mechanism shown in FIGS. 10 and 11, in the engaged configuration.

FIG. 13 illustrates a partially schematic, cross-sectional view of the outer portion shown in FIGS. 10-12, in which the releasable coupling mechanism is in the engaged position and a locking structure is in a locked position.

FIG. 14 illustrates an isometric view of the releasable coupling mechanism in the disengaged configuration generally shown in FIG. 10.

FIG. 15 illustrates a top view of the releasable coupling mechanism in the engaged configuration generally shown in FIGS. 11-13.

FIG. 16 illustrates a representative process that can be executed by a controller to detect and transmit a status of a releasable coupling mechanism.

### DETAILED DESCRIPTION

### Overview

The present technology is directed generally to automatically and releasably coupling UAV propellers to propulsion motors, and associated systems and methods.

Unlike conventional systems, aspects of the present technology are directed to providing automatic coupling or coupling with reduced difficulty and increased security. In particular embodiments, for example, a propeller can be releasably coupled to a propulsion motor using an engagement member positioned to move between an engaged position in which the engagement member couples the propeller to the propulsion motor, and a disengaged position in which the propeller is removable from the propulsion motor. In some embodiments, a UAV can include a control system with a controller carrying a computer-readable medium which can be programmed with instructions to direct or operate a releasable coupling mechanism.

In some embodiments of the present technology, a sensor can detect whether a releasable coupling system has coupled the propeller to the propulsion motor and it can communicate a signal regarding the status of the mechanism to another device, such as a controller, an alarm, or a display, for example. Accordingly, this approach can reduce the time required to install a propeller blade and/or increase safety by providing a warning for a user.

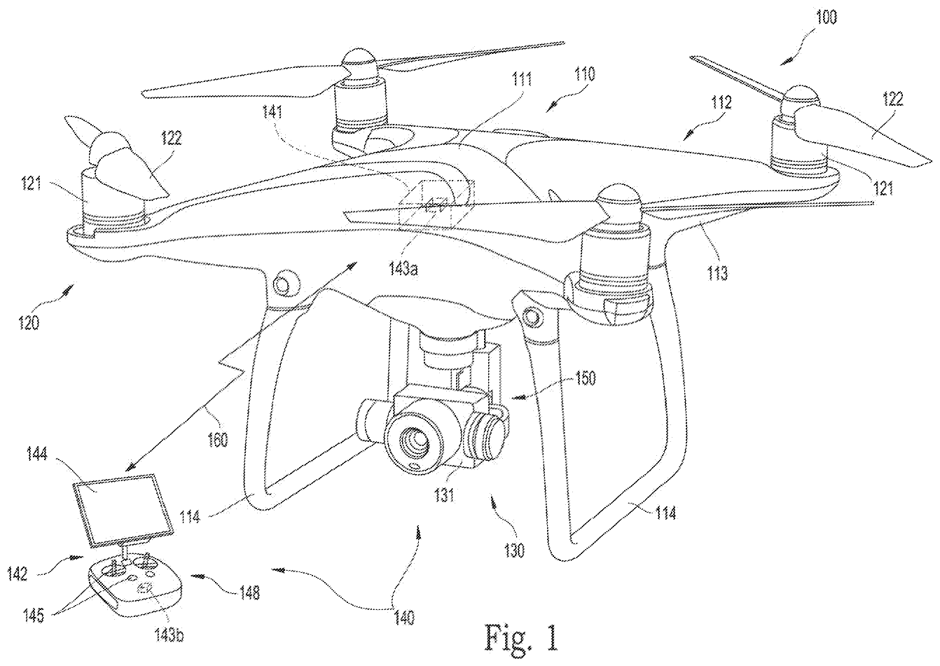

Several details describing structures or processes that are well-known and often associated with UAVs and corresponding systems and subsystems, but that may unnecessarily obscure some significant aspects of the disclosed technology, are not set forth in the following description for purposes of clarity. Moreover, although the following disclosure sets forth several embodiments of different aspects of the technology, several other embodiments can have different configurations or different components than those described in this section. Accordingly, the technology may have other embodiments with additional elements or without several of the elements described below with reference to FIGS. 1-16. FIGS. 1-16 are provided to illustrate representative embodiments of the disclosed technology. Unless provided for otherwise, the drawings are not intended to limit the scope of the claims in the present application.

Many embodiments of the technology described below may take the form of computer-or controller-executable instructions, including routines executed by a programmable computer or controller. Those skilled in the relevant art will appreciate that the technology can be practiced on computer or controller systems other than those shown and described below. The technology can be embodied in a special-purpose computer or data processor that is specifically programmed, configured or constructed to perform one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, mini computers and the like). Information handled by these computers and controllers can be presented at any suitable display medium, including a CRT display or LCD. Instructions for performing computer- or controller-executable tasks can be stored in or on any suitable computer-readable medium, including hardware, firmware or a combination of hardware and firmware. Instructions can be contained in any suitable memory device, including, for example, a flash drive, USB device, and/or other suitable medium.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, unless otherwise specified, terms such as “attached,” “coupled,” or “connected” are intended to include integral connections, as well as connections between physically separate components.

### Representative Embodiments

FIG. 1 is a partially schematic, isometric illustration of a representative UAV 100 configured in accordance with embodiments of the present technology. The UAV 100 can include an airframe 110 that can in turn include a central portion 111 and one or more outer portions 112. In a representative embodiment shown in FIG. 1, the airframe 110 includes four outer portions 112 (for example, arms 113) that are spaced apart from each other as they extend away from the central portion 111. In other embodiments, the airframe 110 can include other numbers of outer portions 112. In any of these embodiments, individual outer portions 112 can support components of a propulsion system 120 that drives the UAV 100. For example, individual arms 113 can support corresponding individual propulsion motors 121 that drive corresponding propellers 122. The individual outer portions 112 (for example, arms 113) and the central portion 111 can also support components of a releasable coupling mechanism and the propellers 122 can be releasably coupled to the propulsion motors 121 using a releasable coupling system that includes the releasable coupling mechanism, as will be described in further detail herein.

The airframe 110 can carry a payload 130, for example, an imaging device 131. In particular embodiments, the imaging device 131 can include a camera, for example, a camera configured to capture video data, still data, or both. In still further embodiments, the payload 130 can include other types of sensors, other types of cargo (for example, packages or other deliverables), or both. In many of these embodiments, the payload 130 is supported relative to the airframe 110 with a gimbal 150 that allows the payload 130 to be independently positioned relative to the airframe 110. When the UAV 100 is not in flight, optional landing gear 114 can support the UAV 100 in a position that protects the payload 130 and other components of the UAV 100, as shown in FIG. 1.

In a representative embodiment, the UAV 100 includes a control system 140 having some components carried on board the UAV 100 and, optionally, some components positioned off the UAV 100. For example, the control system 140 can include a first controller 141 carried by the UAV 100, and a second controller 142 (for example, a human-operated, ground-based controller) positioned remote from the UAV 100 and connected to the first controller 141 via a communication link 160 (for example, a wireless link). The first controller 141 can include an on-board computer-readable medium 143a that executes instructions directing the actions of the UAV 100, including, but not limited to, operation of the propulsion system 120, the imaging device 131, and the releasable coupling system (as will be described in further detail later). The second controller 142 can include an off-board computer-readable medium 143b, and one or more input/output devices 148, for example, a display 144 and control devices 145. In representative embodiments, the operator can manipulate the control devices 145 to control the UAV 100 remotely and the operator can receive feedback from the UAV 100 via the display 144 or other devices. In other representative embodiments, the UAV 100 can operate autonomously, in which case the second controller 142 can be eliminated, or can be used solely for operator override functions. The on-board computer-readable medium 143a can be removable from the UAV 100. The off-board computer-readable medium 143b can be removable from the second controller 142, for example, separable from the one or more input/output devices 148.

The UAV 100 can include the releasable coupling system for releasably coupling the propellers 122 with corresponding propulsion motors 121, as described in further detail below. The releasable coupling system can include a releasable coupling mechanism operated by the first controller 141 or by another suitable controller.

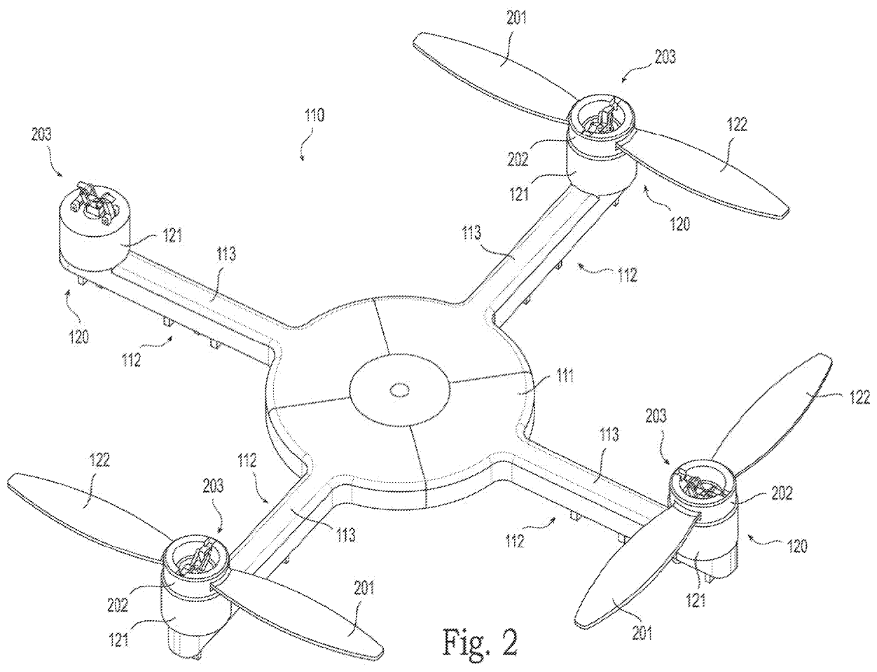

FIG. 2 is a partially schematic, isometric illustration of at least a portion of the airframe 110 shown in FIG. 1 in accordance with a representative embodiment of the present technology. As described above, and in the representative embodiment shown in FIG. 2, the propulsion system 120 includes one or more propulsion motors 121 that drive corresponding propellers 122. Each propeller 122 can include at least one blade element 201 attached to a hub portion 202. For example, each propeller 122 can include two blade elements 201 or any other suitable number of blade elements 201. A releasable coupling mechanism 203 can releasably couple each propeller 122 to each corresponding propulsion motor 121 via each corresponding hub portion 202.

For purposes of illustration and explanation, FIG. 2 includes three propellers 122. A fourth propeller 122 has been omitted from FIG. 2 to expose at least a portion of the releasable coupling mechanism 203 to aid in understanding the technology. In FIG. 2, the releasable coupling mechanism 203 is in a disengaged or unlocked configuration, such that the propellers 122 can be placed onto and removed from their respective propulsion motors 121. In other words, FIG. 2 illustrates an example of a partially assembled arrangement in which a user has placed three propellers 122 onto the airframe 110. To further assemble the UAV 100, the user can place another propeller 122 onto the airframe 110 and cause the releasable coupling mechanism 203 to move to an engaged or locked configuration for flight operations or other reasons, as further described below.

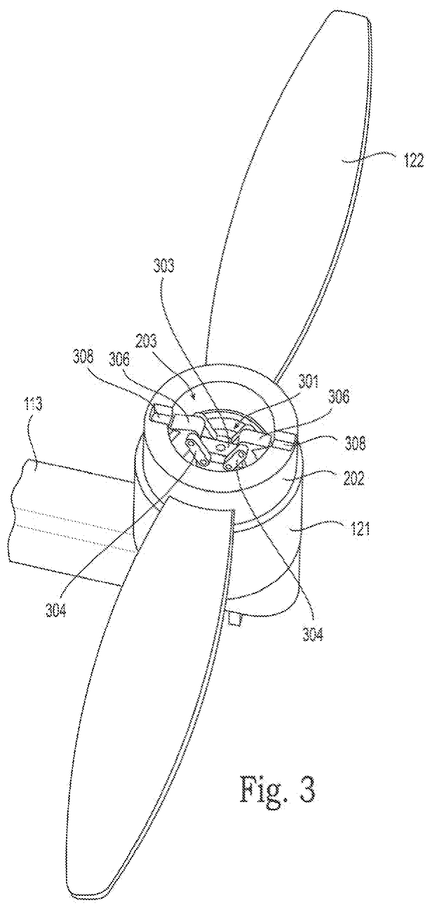

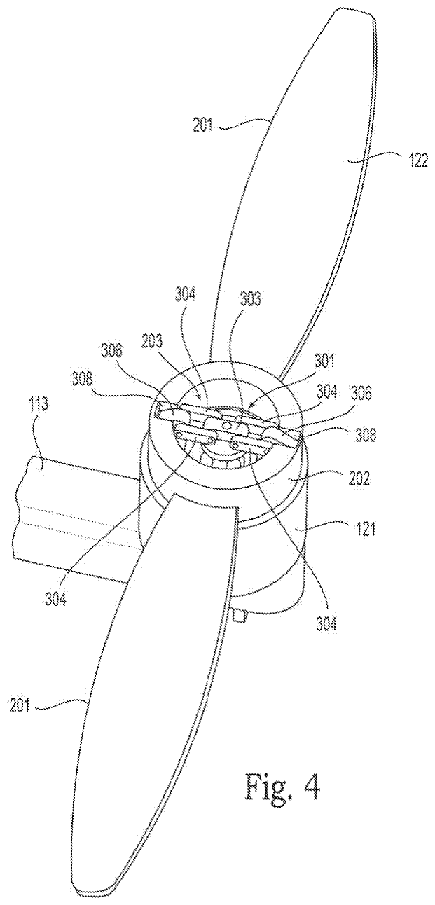

FIG. 3 is a partially schematic, isometric illustration of the releasable coupling mechanism 203 in the disengaged configuration also shown in FIG. 2. As will be explained in further detail below, the releasable coupling mechanism 203 can include an engagement member 301 positioned and configured to move relative to the propulsion motor 121 and the hub portion 202 between a disengaged position (illustrated in FIG. 3) and an engaged position (described below with reference to FIG. 4) in which at least a portion of the engagement member 301 of the releasable coupling mechanism 203 couples the propeller 122 (via the hub portion 202) to the propulsion motor 121.

In the embodiment generally illustrated in FIG. 3, a portion of the engagement member 301 can pass through the propulsion motor 121 and can be positioned to move along a rotational axis of the propulsion motor 121 between an engaged position in which the engagement member 301 couples the propeller 122 to the propulsion motor 121 and a disengaged position different from the engaged position. When the engagement member 301 of the releasable coupling mechanism 203 is in the disengaged position, a piston element 303 is drawn downward into the hub portion 202 towards the propulsion motor 121, which causes one or more linkage elements 304 to pull a pair of hook elements 306 inwardly, out of and away from recesses 308 in the hub portion 202. In such a configuration, the propeller 122 is not restrained relative to the propulsion motor 121. Accordingly, the propeller 122 is generally free to be placed upon and removed from the propulsion motor 121 for assembly or disassembly by a user or for other operations. The recesses 308 can be formed as notches in one or more surfaces of the hub portion 202, for example, an interior surface or an upper surface.

The linkage elements 304 may include a connecting rod, a crank, a cam, or a gear. In the illustrated embodiment, the linkage elements 304 can include a connecting rod. One end of the connecting rod is rotatably connected to the hook element 306, and the other end of the connecting rod is rotatably connected to the piston element 303, such that the piston element 303 drives the hook element 306 via the linkage elements 304.

In some embodiments, at least a portion of the engagement member 301 can be positioned at an outer side of the propulsion motor 121. In other embodiments, at least a portion of the engagement member 301 can pass through the propulsion motor 121. In some embodiments, an engagement member can be attached to an outer shell of the propulsion motor 121 such that it does not pass through the propulsion motor 121.

The engagement member 301 can move relative to the propulsion motor 121 by any suitable mechanism or means for providing motion. In some embodiments, a portion of the engagement member 301 can move relative to the propulsion motor 121, for example, by sliding in the propulsion motor 121. In some embodiments, a portion of the engagement member can slide along an outer side of the propulsion motor 121. In yet other embodiments, a portion of the engagement member 301 can rotate relative to the propulsion motor 121 by a joint point or a shaft.

FIG. 4 is a partially schematic, isometric illustration of the releasable coupling mechanism 203 in the engaged configuration, in which the piston element 303 of the engagement member 301 is pushed upward through the hub portion 202 away from the propulsion motor 121. The piston element 303 causes the linkage elements 304 to push and rotate the hook elements 306 outwardly. The hook elements 306 engage with the recesses 308 in the hub portion 202. In such a configuration, the propeller 122 is coupled to the propulsion motor 121. The propulsion motor 121 can thereby rotate the propeller 122 for flight.

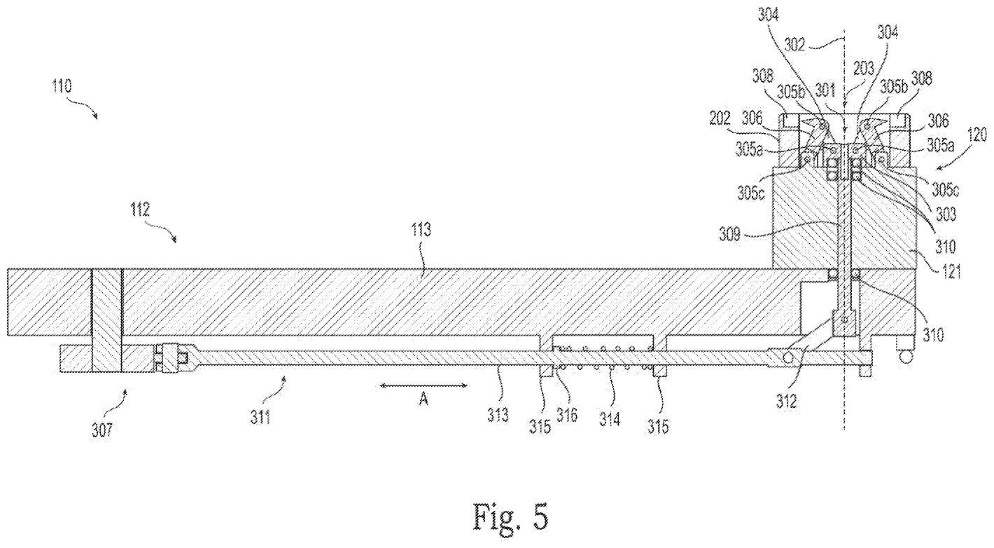

Additional details of the representative releasable coupling mechanism 203 are shown in FIG. 5. FIG. 5 is a partially schematic, cross-sectional illustration of a portion of the airframe 110 shown in FIGS. 1-3, in which several elements of the releasable coupling mechanism 203 are shown. Note that in order to avoid obscuring FIG. 5, the blade elements 201 (FIG. 4) are not illustrated. Rather, only the hub portion 202 of a propeller 122 is illustrated, although it is to be understood that the hub portion 202 carries blade elements 201.

The engagement member 301 of the releasable coupling mechanism 203 is positioned and configured to move relative to the propulsion motor 121 and the hub portion 202 along a rotational axis 302 of the propulsion motor 121 between a disengaged position (illustrated in FIGS. 3 and 5 for example) and an engaged position (illustrated in FIG. 4 for example) in which at least a portion of the engagement member 301 couples the propeller (via the hub portion 202) to the propulsion motor 121.

In accordance with a representative embodiment, the airframe 110 can carry the engagement member 301, which can carry the piston element 303. The piston element 303 can be pivotably connected to the one or more linkage elements 304 via one or more corresponding first pin joints 305a or other suitable pivotable connections. In turn, each linkage element 304 can be pivotably connected to a corresponding hook element 306 via a corresponding second pin joint 305b or other suitable pivotable connection. Each hook element 306 can also be pivotably connected to the propulsion motor 121 via still another corresponding third pin joint 305c or other suitable pivotable connection.

In an operation in accordance with a representative embodiment, the piston element 303 is moved along the axis 302. As the piston element 303 moves, it pushes or pulls each linkage element 304, which in turn pushes or pulls each corresponding hook element 306 such that each hook element 306 pivots about its respective third pin joint 305c connected to the propulsion motor 121. As each hook element 306 pivots, it engages with or disengages from its corresponding recess 308 in the hub portion 202. FIGS. 2, 3, and 5 show such a disengaged position of the hook elements 306, in which the propeller 122 is generally free to be placed upon or removed from the propulsion motor 121. FIG. 4 shows each hook element 306 in engaged positions to couple the propeller 122 to the propulsion motor 121 via the hub portion 202.

An elongated rod element 309 can be connected to the piston element 303 and positioned to move along the axis 302 of the propulsion motor 121 to move the piston element 303. In such an embodiment, the piston element 303 can be rotatably connected to the elongated rod element 309. Such a rotatable connection between the piston element 303 and the elongated rod element 309 can be formed using a bearing 310 or another suitable rotatable connecting device. Additional bearings 310 can be implemented between the elongated rod element 309 and the propulsion motor 121 to enable rotation of the propulsion motor 121 relative to the elongated rod element 309 during operation. Note that while the propulsion motor 121 is in operation (rotating), the piston element 303, linkage elements 304, and hook elements 306 rotate with the propulsion motor relative to the elongated rod element 309. In some embodiments, a user can manipulate the elongated rod element 309 manually or directly to engage and disengage the releasable coupling mechanism 203.

It should be understood that the elongated rod element 309 may be capable of satisfying any desired length, and may include an elongated rod member, a telescopic cylinder, a telescopic rod, or a linear motor. In the illustrated embodiment, the elongated rod element 309 can include a connecting rod.

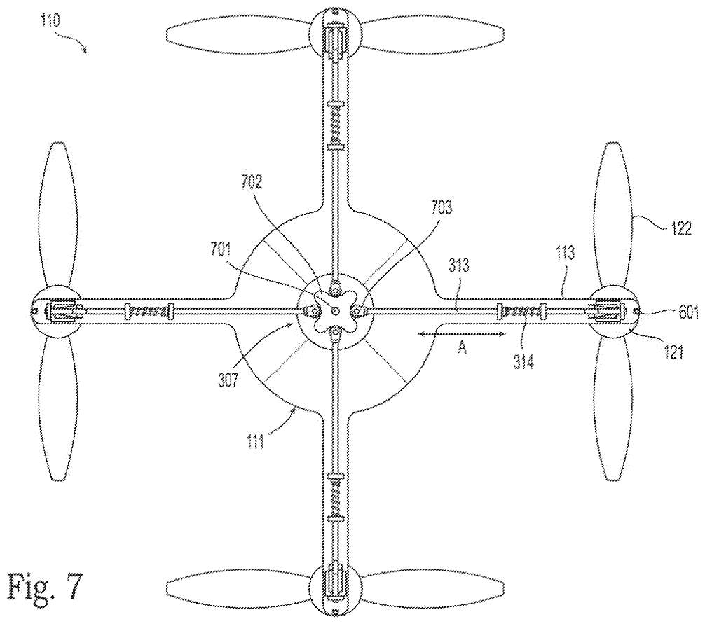

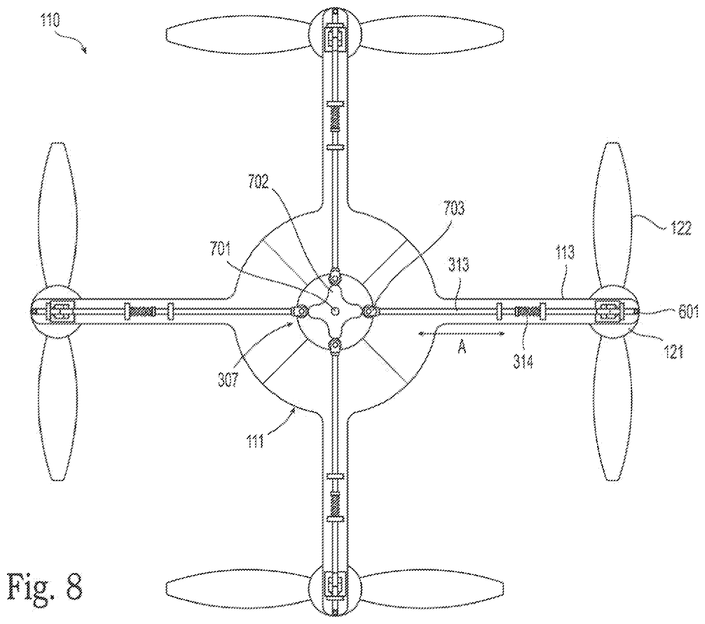

In representative embodiments, a driving mechanism 307 operably connected to the elongated rod element 309 can drive the releasable coupling mechanism 203 between configurations. For example, one or more transmission links 311 can connect the driving mechanism 307 to the elongated rod element 309. Any suitable number of transmission links can be used, for example, two transmission links can be used in various embodiments. In a representative embodiment, a first transmission link 312 is pivotably connected to the elongated rod element 309 at one end and pivotably connected to a second transmission link 313 at another end. The second transmission link 313 can be positioned to be in contact with the driving mechanism 307 to be moved along a direction generally parallel to a length of the second transmission link 313 (for example, along arrow A). The driving mechanism 307, described in additional detail below, can include an actuator to cause the transmission links 311 to move, or in some embodiments, the driving mechanism 307 can be manually operated. Additional details of a representative driving mechanism 307 are provided below with reference to FIGS. 7 and 8.

It should be understood that the actuator can include a motor, a cylinder, a magnet assembly, or the like. In the illustrated embodiment, the actuator may be a motor configured to cause the transmission links 311 to move.

The transmission links 311 can be spring-biased to bias the releasable coupling mechanism toward the disengaged configuration (such as shown in FIG. 5). For example, a resilient element 314 can be positioned along a portion of the second transmission link 313 between a pair of walls 315 through which the transmission link 313 can pass. A shoulder 316 on the second transmission link 313 can be positioned to compress the resilient element 314 as the second transmission link 313 moves. The resilient element 314 exerts a spring force against the shoulder 316 to bias the second transmission link 313. The resilient element 314 may be a spring, a metal shrapnel, a rubber tube, a rubber cord, etc. In the illustrated embodiment, the resilient element 314 is a compression spring.

Although a representative embodiment illustrated in FIG. 5 includes the second transmission link biased to move the releasable coupling mechanism toward the disengaged configuration, in other embodiments it can be biased to move the releasable coupling mechanism toward the engaged configuration. In still further embodiments, the releasable coupling mechanism can be biased toward the disengaged configuration or toward the engaged configuration using other suitable arrangements of one or more springs or other elements suitable for imparting bias in or upon the mechanism.

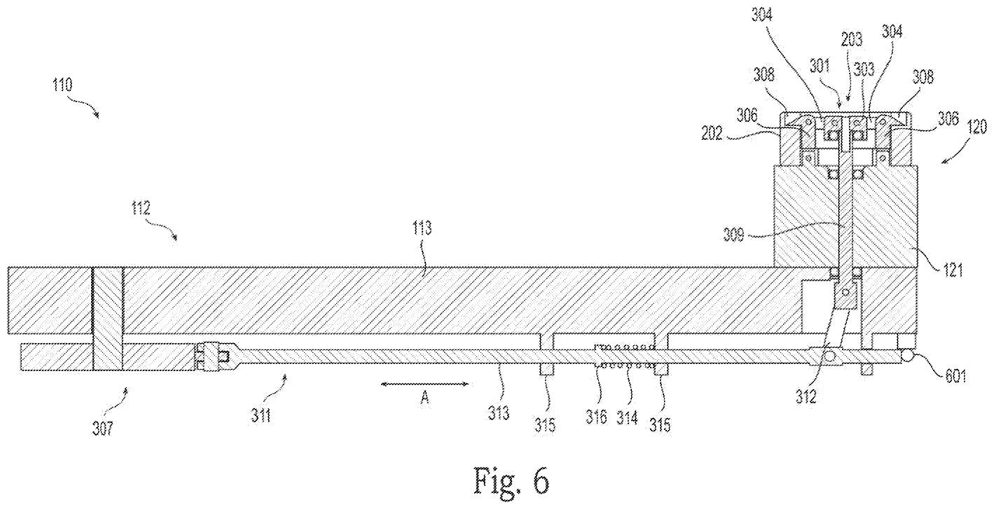

FIG. 6 is a partially schematic, cross-sectional illustration of the portion of the airframe 110 shown in FIG. 5 in which the releasable coupling mechanism 203 has been moved to an engaged configuration. In the engaged configuration, the hook elements 306 engage the recesses 308 to couple the hub portion 202 of the propeller 122 to the propulsion motor 121 for flight (only the hub portion of the propeller is illustrated).

In some embodiments of the present technology, a sensor assembly 601 can be attached to the UAV to detect a configuration of the releasable coupling mechanism 203 (for example, engaged or disengaged). In a representative embodiment, the sensor assembly 601 can be attached to one or more of the arms 113 to detect a position of a transmission link 311 such as the second transmission link 313. In an embodiment such as one similar to the embodiment illustrated in FIG. 6, the sensor assembly 601 is arranged to detect the position of an end of the second transmission link 313. In some embodiments, the sensor assembly can include a touch switch or a proximity sensor such as an infrared (IR) emitter-detector pair, while in other embodiments, other suitable sensor assemblies can be implemented to detect positions of the second transmission link 313 or other elements of the driving mechanism or releasable coupling mechanism.

FIG. 7 illustrates a partially schematic bottom view of a portion of the airframe 110 shown in at least FIGS. 1 and 5 in accordance with a representative embodiment of the present technology. The driving mechanism 307 can include a cam element 701 having at least one lobe 702 (for example, 4 lobes). The cam element 701 can be rotated by a driving motor or manually by a user. When the cam element 701 rotates, one or more of the lobes 702 engage an end 703 of the second transmission link 313 to cause the second transmission link 313 to operate the releasable coupling mechanism 203 via the first transmission link 312 (FIGS. 5 and 6) and the elongated rod element 309 (FIGS. 5 and 6). Each end 703 of the second transmission link 313 can include a wheel, roller bearing, or other device to reduce friction against the face of the cam element 701. In the configuration generally illustrated in FIG. 7, the second transmission link 313 is biased toward a depression between lobes 702 of the cam element by the resilient element 314 and the releasable coupling mechanism is in a disengaged configuration (for example, as shown in FIG. 5).

FIG. 8 illustrates a partially schematic bottom view of the portion of the airframe 110 shown in FIG. 7, in a configuration in which the cam element 701 has been rotated to push the second transmission link 313 outwardly along arrow A. In such a configuration, the releasable coupling mechanism is in an engaged configuration and the propeller 122 is coupled to the propulsion motor 121 for flight or other operations (for example, as shown in FIGS. 4 and 6). Note that although a cam element 701 is described as an example for operating the transmission links 311, other embodiments can include other suitable driving mechanisms such as linear actuators. The linear actuator may include a rotating motor, a linear motor, or a telescopic cylinder. For example, the linear actuator may include a rotating motor and a lead screw connected to a drive shaft of the rotating motor.

In several embodiments of the technology generally described above with reference to FIGS. 2 to 8, the second transmission link 313 can be configured to be oriented generally parallel to an arm 113 forming part of an airframe 110 of a UAV 100. In some embodiments, the second transmission link 313 or another transmission link can be mounted within an interior region of the arm 113, while in other embodiments, one or more of the transmission links 311 can be attached to an exterior region or surface of the arm 113.

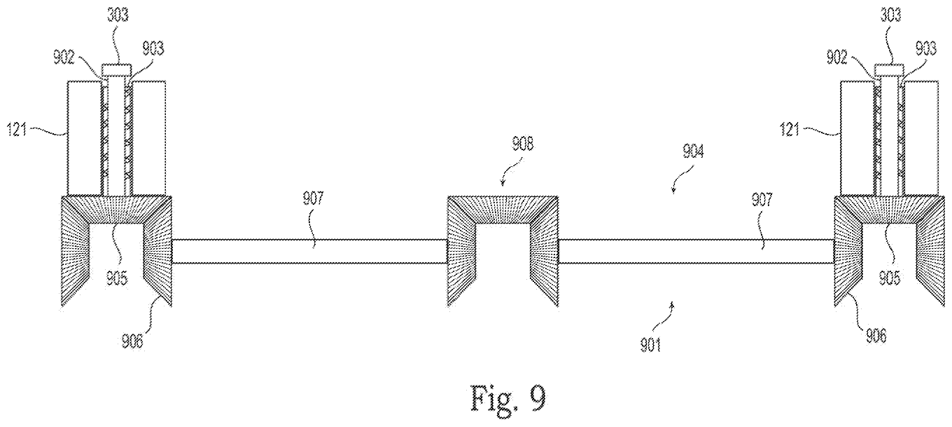

FIG. 9 illustrates a schematic cross-sectional view of another representative embodiment of a driving mechanism 901 for operating a releasable coupling mechanism in accordance with the present technology. An elongated rod element 902 may be positioned to move a piston element 303 in a similar manner as described above with regard to the elongated rod element 309 and the piston element 303 in the foregoing figures and corresponding description. In the embodiment generally illustrated in FIG. 9, however, the elongated rod element 902 may be a threaded rod positioned to move within a threaded bore 903 positioned within the propulsion motor 121. Rotating the threaded elongated rod element 902 causes it to move up and down to drive the piston element 303. The elongated rod element 902 may be driven (rotated) by a bevel gear transmission 904, which can include a first bevel gear 905 connected to the elongated rod element 902, a second bevel gear 906 in operative engagement with the first bevel gear 905, and an elongated driveshaft 907 positioned to drive the second bevel gear 906. Each elongated driveshaft 907 can be driven by a suitable driving motor directly or through another set of bevel gears 908. Accordingly, a driving motor may provide rotation to the elongated rod element 902 via the bevel gears and driveshaft to cause the elongated rod element 902 to move up and down to drive the piston element 303 to engage and disengage the propeller with an embodiment of a releasable coupling mechanism described above. Although outer bevel gears positioned opposite the second bevel gears 906 are illustrated, such bevel gears are optional and can be eliminated in some embodiments of the present technology.

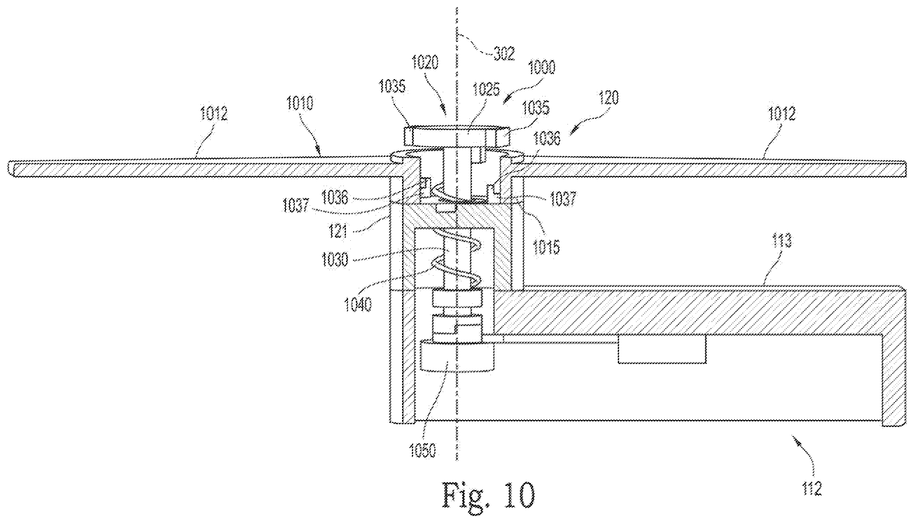

FIG. 10 illustrates a partially schematic, cross-sectional view of an outer portion 112 (such as an arm 113) of an airframe for a UAV (such as the airframe 110 and the UAV 100 described above) having a releasable coupling mechanism 1000 configured in accordance with another representative embodiment of the present technology. In FIG. 10, an engagement member 1020 of the releasable coupling mechanism 1000 is in a disengaged configuration, in which a propeller 1010 can be separated from or placed onto the propulsion motor 121 for assembly or disassembly of the propulsion system 120. The propeller 1010 can include a hub portion 1015 and one or more blade elements 1012 (for example, two blade elements) attached to the hub portion 1015.

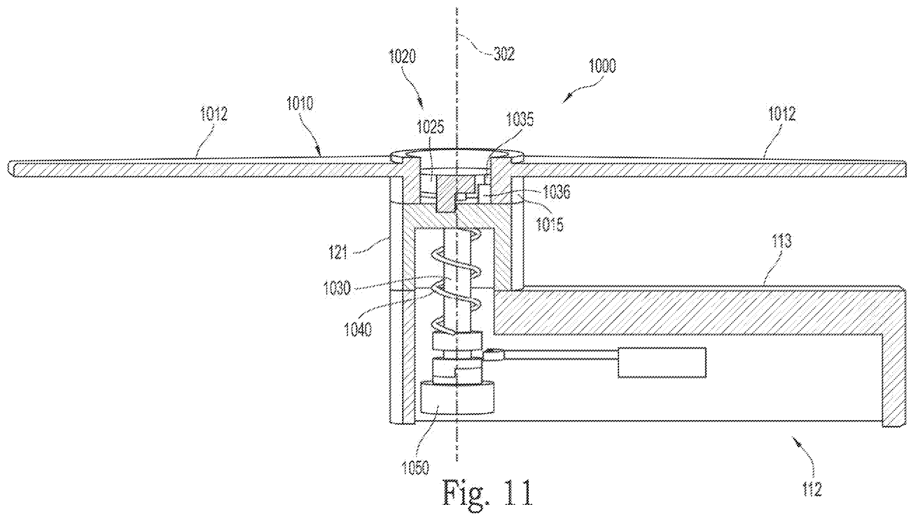

The engagement member 1020 includes a disk portion or disk element 1025 and an elongated rod portion or rod element 1030 that carries the disk element 1025. As will be described in further detail below, the disk element 1025 has one or more flange elements 1035 positioned and configured to engage one or more corresponding recessed portions or recesses 1036 in the hub portion 1015 to facilitate coupling between the propeller 1010 and the propulsion motor 121 when the engagement member 1020 or the disk element 1025 is in the engaged position (such as in FIG. 11-13 or 15, described below). Such recessed portions or recesses 1036 can be formed in one or more lip elements 1037 extending from an interior surface of the hub portion 1015.

The disk element 1025 of the engagement member 1020 is positioned and configured to move along the rotational axis 302 of the propulsion motor 121 and to rotate about the axis 302 to engage with or disengage from the recesses 1036 via the flange elements 1035. A biasing spring 1040 can be positioned to bias the engagement member 1020 away from the disengaged position and toward the engaged position. For example, the biasing spring 1040 can be positioned around the elongated rod element 1030 within the interior of the propulsion motor 121 and configured to bias the engagement member 1020 downward towards the arm 113. In some embodiments, to move the engagement member 1020 into the disengaged position, a driving mechanism such as an actuator 1050 can be positioned in or on the arm 113 and configured to cause the engagement member 1020 to translate or move axially (upwardly and downwardly) and to rotate between the engaged and disengaged positions. FIG. 10 generally illustrates the actuator 1050 driving the engagement member 1020 to the disengaged position. The actuator 1050 may be a cylinder, a motor, a magnet assembly, etc. In the illustrated embodiment, the actuator 1050 can be a rotating motor. In other embodiments, the actuator 1050 may also be a rotary cylinder.

FIG. 11 illustrates a partially schematic, cross-sectional view of the outer portion 112 with the releasable coupling mechanism 1000 shown in FIG. 10 in the engaged configuration. The actuator 1050 has been retracted downwardly along the axis 302 and rotated around the axis 302 to position the flange elements 1035 in the recesses 1036 of the hub portion 1015. The biasing spring 1040 can cause the engagement member 1020 to move downwardly along the axis 302 as the actuator 1050 retracts downwardly, in order to maintain contact between the engagement member 1020 and the actuator 1050.

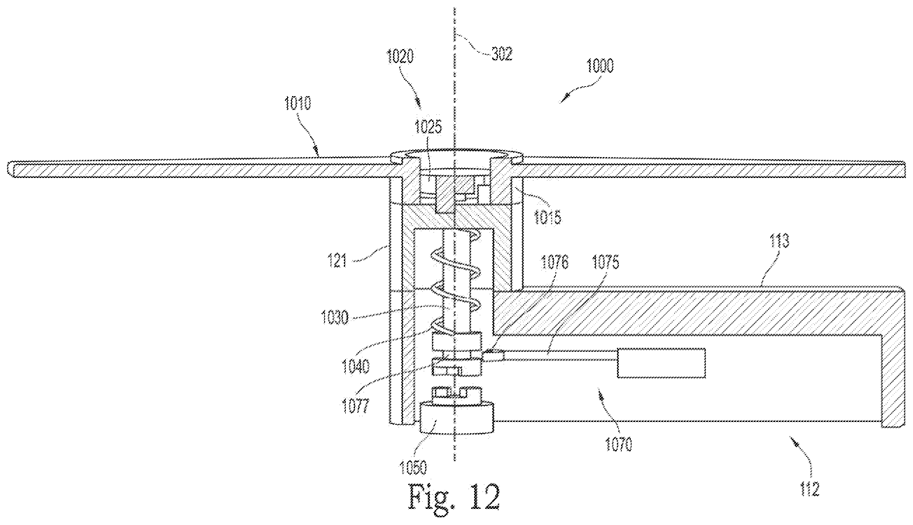

During flight of the UAV 100 or other operations in which the propeller 1010 is coupled to the propulsion motor 121 and the propulsion motor 121 rotates the propeller 1010, the engagement member 1020 rotates with the propulsion motor 121 and the propeller 1010. Accordingly, for embodiments using an actuator 1050 to move the engagement member 1020, the actuator 1050 can be moved farther down the axis 302 to be spaced apart from and decoupled from the engagement member 1020 when the engagement member 1020 is in the engaged position, as illustrated in FIG. 12.

FIG. 12 illustrates a partially schematic, cross-sectional view of the outer portion 112 with the releasable coupling mechanism 1000 shown in FIGS. 10 and 11 in the engaged configuration. To allow the engagement member 1020 to rotate generally freely while the propulsion motor 121 is in operation and turning the propeller 1010, the actuator 1050 has moved axially (downwardly) away from an end of the elongated rod element 1030.

A locking structure 1070 can be positioned to maintain the engagement member 1020 in the engaged position. For example, the locking structure 1070 can include an arm 1075 carrying a collar 1076 that engages a corresponding rounded slot 1077 in the elongated rod element 1030. In FIG. 12, the locking structure 1070 is spaced apart from the slot 1077 to allow the engagement member 1020 to move along the axis 302.

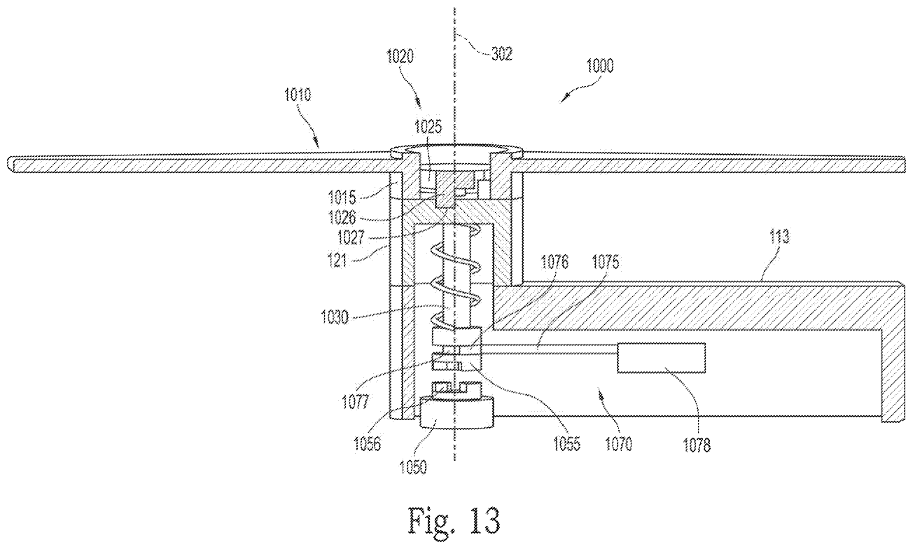

The locking structure 1070 is adapted to engage with a portion of the engagement member 1020 to prevent or at least resist movement of the engagement member 1020 along the rotational axis 302 of the propulsion motor 121 when the engagement member 1020 is in the engaged position (the engagement member 1020 is in the engaged position in FIG. 12; see FIG. 13 for an illustration of the locking structure 1070 engaged with a portion of the engagement member 1020).

For example, when the engagement member 1020 is in a locked configuration (which is generally illustrated in FIG. 13 and described in additional detail below), the engagement member 1020 engages with the propeller 1010 at a first portion of the engagement member, and engages with the locking structure 1070 at a second portion of the engagement member, in order to prevent or at least resist vertical/horizontal movement of the propeller 1010 relative to the propulsion motor 121. When the engagement member 1020 is in an unlocked configuration (which is generally illustrated in FIG. 10 and described in additional detail above), the engagement member 1020 is disengaged from the propeller 1010 and disengaged from the locking structure 1070, in order to allow vertical/horizontal movement of the propeller 1010 relative to the propulsion motor 121. In some embodiments, when the engagement member 1020 is in the unlocked configuration, the engagement member may engage a different portion of the locking structure 1070.

FIG. 13 illustrates a partially schematic, cross-sectional view of the outer portion 112 shown in FIGS. 10-12, in which the releasable coupling mechanism 1000 is in the engaged position and the locking structure 1070 is in a locked position. In the locked position, the arm 1075 with the collar 1076 engages the slot 1077 in the elongated rod element 1030 to prevent or at least resist movement of the elongated rod element 1030 along the axis 302. Accordingly, the locking structure 1070 prevents the engagement member 1020 from moving to a disengaged position in which the propeller 1010 could be released from the propulsion motor 121.

In some embodiments, the locking structure 1070 can include an actuator 1078 positioned to move the arm 1075 between engagement with the rounded slot 1077 and disengagement from the rounded slot 1077. The locking structure 1070 can include a transmission structure, such that the actuator 1078 can engage with the engagement member 1020 via the transmission structure. The actuator 1078 can include a motor, a cylinder, an electromagnet, and/or other suitable mechanisms or elements for causing motion. The transmission structure can include a connecting rod (such as the arm 1075), a gear, a wheel, a belt, a chain, a link, a joint, a latching structure, a friction structure, a grasping structure, and/or another suitable mechanism allowing the actuator 1078 to interact with (for example, contact) the engagement member 1020. The actuator 1078 may include a rotating motor, a linear motor, or a telescopic cylinder. For example, the actuator 1078 can include a rotating motor and a lead screw connected to a drive shaft of the rotating motor.

Optionally, in some representative embodiments, an end of the elongated rod element 1030 can include a notched or contoured coupling surface 1055 that is optionally shaped and positioned to interlock with a corresponding notched or contoured coupling surface 1056 on the actuator 1050 when the actuator 1050 moves and rotates the elongated rod element 1030.

In some embodiments, the disk element 1025 has a detent element 1026 protruding from a surface of the disk element 1025 to engage with a notch 1027 in the propulsion motor 121 to assist with the transfer of rotational forces from the propulsion motor 121 to the hub portion 1015 during operation of the UAV.

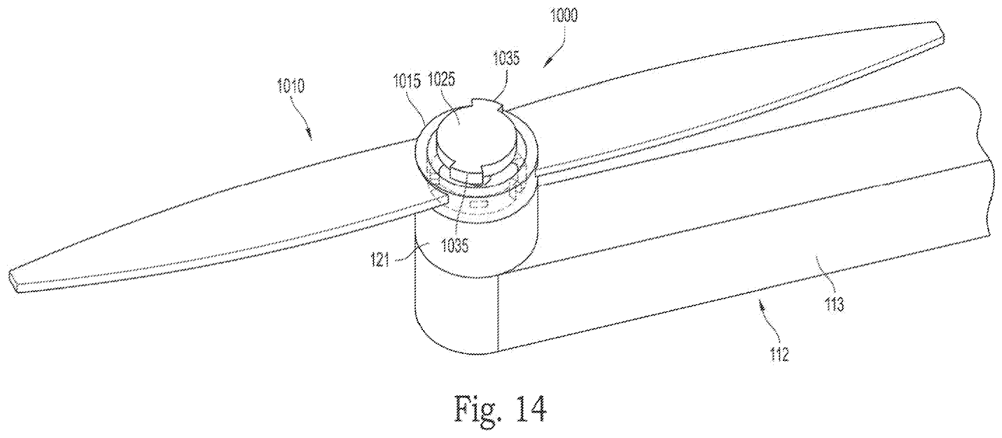

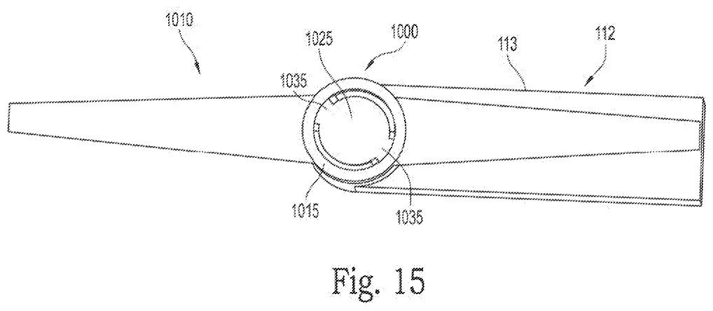

FIGS. 14 and 15 illustrate additional views of the outer portion 112 having the releasable coupling mechanism 1000 shown in FIGS. 10-13. FIG. 14 illustrates an isometric view of the releasable coupling mechanism 1000 in the disengaged configuration illustrated in FIG. 10. FIG. 15 illustrates a top view of the releasable coupling mechanism 1000 in the engaged configuration illustrated in FIGS. 11-13.

### Sensor Assemblies, Controllers, and Control Systems

In use, the presently disclosed technology allows an operator or user to couple a propeller to a UAV by placing the propeller onto the UAV, on or adjacent to releasable coupling mechanism components in accordance with embodiments of the technology, and operating the releasable coupling mechanism manually, automatically, or otherwise. For example, a controller (such as the controller 141 described above with reference to FIG. 1, or another suitable controller) can include a computer-readable medium programmed with instructions to receive a request to operate a releasable coupling system or mechanisms such as those disclosed herein and, in response to the request, operate the releasable coupling mechanism to couple a propeller to a propulsion motor, or to decouple (release) the propeller from a propulsion motor. For example, in some embodiments, a controller or control system is programmed to operate the cam element 701 described above with reference to FIGS. 7 and 8. In some embodiments, releasable coupling systems in accordance with the present technology can activate automatically in response to a user placing the propeller on a propulsion motor. For example, a sensor positioned on the propulsion motor can be positioned to detect placement of the propeller on the propulsion motor.

Releasable coupling systems in accordance with embodiments of the present technology can include one or more sensor assemblies positioned to sense whether a releasable coupling mechanism or a portion thereof is in an engaged configuration or in a disengaged configuration. Such sensors can optionally be positioned to sense whether a part of an engagement member is in an engaged position. One representative sensor assembly 601 is described above with reference to FIG. 6, in which the sensor assembly 601 is arranged to detect a position of an end of the second transmission link 313.

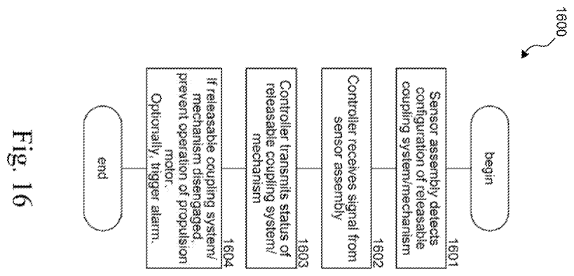

UAVs, propulsion systems carried by the UAVs, or releasable coupling systems associated with UAVs in accordance with embodiments of the present technology can include controllers programmed with instructions that use signals from such sensors to monitor the status of a coupling mechanism. For example, FIG. 16 illustrates a representative process 1600 for operating a sensor that can be programmed on and executed by a controller (for example, the controller 141 described above with reference to FIG. 1) or otherwise suitably programmed for execution on one or more computers, processors, or other systems suitable for performing computing routines.

In operation, a sensor can detect a configuration of the releasable coupling mechanism (block 1601), which can be either a disengaged configuration or an engaged configuration as described herein. The controller can receive a signal from the sensor assembly indicating the configuration (block 1602). For example, the controller can receive a signal indicating whether a portion of the engagement member is in the engaged position or whether a transmission link (such as transmission link 313) is in a position to cause the mechanism to be in the engaged position. The controller can transmit or cause to be transmitted a status of the releasable coupling system or the propulsion system corresponding to the signal (block 1603). For example, the status can be transmitted to a remote control or to another controller or instruction programmed on the controller.

In some embodiments, the controller can prevent the propulsion motor from operating if the releasable coupling system or mechanism is determined to be in the disengaged configuration (block 1604). In yet other embodiments, the controller can transmit an alarm signal to a remote terminal or cause an alarm device (such as a light or audio device) to operate based on whether the releasable coupling system or mechanism has coupled the propeller to the propulsion motor. In some embodiments, the alarm signal can be transmitted during flight of the UAV (for example, if a releasable coupling mechanism becomes disengaged during flight). In some embodiments, a user can request a check from the sensor assembly during flight to confirm engagement of the propellers to the propulsion motors.

### Kits for assembling UAVs with Releasable Coupling Systems or Mechanisms

UAVs in accordance with several embodiments of the presently disclosed technology can be assembled from a kit of parts. In some embodiments, such a kit of parts can include an airframe, one or more propulsion motors, one or more propellers, and a plurality of releasable coupling mechanism components for assembling releasable coupling mechanisms or systems described herein with reference to FIGS. 2-15, for example. Kits in accordance with embodiments of the present technology may also include instructions with information for assembling the components into a system or a UAV.

One feature of several of the embodiments described herein is that rather than having to tighten a propeller to a UAV without knowing if it is sufficiently tight, a user can be confident that it is secured because of feedback from a sensor assembly (such as the sensor assembly 601 shown in FIG. 6) or because of the nature of the disengaged and engaged positions of releasable coupling mechanisms and systems described herein.

From the foregoing, it will be appreciated that specific embodiments of the technology have been described herein for purposes of illustration, but that various modifications may be made without deviating from the technology. For example, particular embodiments were described above in the context of an elongated rod element (such as the elongated rod element 309 described above with reference to FIGS. 5 and 6). In another representative embodiment, the elongated rod element may comprise two or more telescopic cylinders. In still further embodiments, engagement members or portions of engagement members can be operated by other transmission components, such as one or more belts, chains, gears, or other elements to cause the engagement members disclosed herein to move. In still further embodiments, propellers (such as a propeller 122 and/or a propeller 1010 described above) can include detachable blades (such as blades 201, 1012 described above) and/or detachable blade portions, such that the blades and/or blade portions can be removed from, replaced on, and/or releasably attached to the hub portion (such as hub portions 202 or 1015 described above).

In general, controllers or other computing devices programmed in accordance with embodiments of the present technology can be positioned on a UAV, in a remote control device (such as controller 142 described above with reference to FIG. 1), or in another suitable location capable of operating a releasable coupling mechanism by wired or wireless transmission. Kits of parts in accordance with various embodiments of the presently disclosed technology can include additional or fewer parts. Sensors for detecting the position of various elements of the technology can be positioned as disclosed herein or in other suitable locations for determining a status of a releasable coupling mechanism.

Particular embodiments were described above in the context of a UAV having one or more arms or outer portions. In general, the technology disclosed herein can be implemented in other UAVs or vehicles having overall configurations other than those specifically shown or described herein, such as UAVs without arms extending from a central portion, or other robotic, unmanned, or autonomous vehicles that are not necessarily aerial vehicles. Certain aspects of the technology described in the context of particular embodiments may be combined or eliminated in other embodiments. For example, sensor assemblies (such as sensor assembly 601) can be implemented in embodiments such as those generally illustrated in FIGS. 9-16.

Further, while advantages associated with certain embodiments of the technology have been described in the context of those embodiments, other embodiments may also exhibit such advantages, and not all embodiments need necessarily exhibit such advantages to fall with within the scope of the present technology. Accordingly, the present disclosure and associated technology can encompass other embodiments not expressly shown or described herein.

To the extent any materials incorporated herein conflict with the present disclosure, the present disclosure controls.

At least a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A propulsion system for an unmanned aerial vehicle (UAV), the propulsion system comprising:
a propulsion motor configured to drive a propeller; and
an apparatus configured to releasably couple the propeller to the propulsion motor, the apparatus comprising an engagement member, at least a portion of the engagement member being positioned to move relative to the propulsion motor and/or the propeller along a rotational axis of the propulsion motor between an engaged position in which the engagement member couples the propeller to the propulsion motor and a disengaged position different from the engaged position.

2. The propulsion system of claim 1, further comprising a driving mechanism operatively connected to the engagement member to cause the portion of the engagement member to move between the engaged position and the disengaged position.

3. The propulsion system of claim 1,
wherein the engagement member includes a first hook element pivotably connected to the propulsion motor;
the propulsion system further comprising a second hook element pivotably connected to the propulsion motor.

4. The propulsion system of claim 3, wherein the first hook element is positioned to be:
received in a recess in a hub portion of the propeller when the engagement member is in the engaged position, and
disengaged from the recess when the engagement member is in the disengaged position.

5. The propulsion system of claim 4, wherein:
the engagement member includes a piston element pivotably connected to the first hook element via a linkage element; and
the piston element is moveable along the rotational axis of the propulsion motor to cause the first hook element to move between a position to be received in the recess and a position to be disengaged from the recess.

6. The propulsion system of claim 5, further comprising:
an elongated rod element positioned to move the piston element;
wherein the elongated rod element comprises:
two or more telescopic cylinders; or
a threaded rod positioned to move within a threaded bore positioned within the propulsion motor.

7. The propulsion system of claim 6, further comprising:
a bevel gear transmission;
wherein:
the elongated rod element comprises the threaded rod operatively connected to the bevel gear transmission; and
the bevel gear transmission comprises:
a first bevel gear operatively connected to the threaded rod;
a second bevel gear in operative engagement with the first bevel gear; and
an elongated driveshaft operatively connected to the second bevel gear and positioned to apply a rotational force to the second bevel gear.

8. The propulsion system of claim 6,
wherein the elongated rod element moves within the propulsion motor;
the propulsion system further comprising at least one bearing element positioned between the elongated rod element and the propulsion motor.

9. The propulsion system of claim 6, further comprising:
one or more transmission links; and
a driving mechanism operatively coupled to the elongated rod element via the one or more transmission links and configured to move the elongated rod element via the one or more transmission links.

10. The propulsion system of claim 9, wherein:
the one or more transmission links comprise:
a first transmission link pivotably connected to the elongated rod element; and
a second transmission link pivotably connected to the first transmission link, the driving mechanism being in operative contact with the second transmission link;
the driving mechanism comprises a cam element having at least one lobe, the cam element being rotatable and operatively coupled to an end of the second transmission link; and
the cam element is positioned to move the second transmission link and the first transmission link, to cause the elongated rod element to move the piston element.

11. The propulsion system of claim 10, further comprising a bearing attached to the end of the second transmission link and positioned to be in operative contact with the cam element.

12. The propulsion system of claim 10, further comprising a resilient element positioned to bias the second transmission link toward a configuration in which the second transmission link causes the hook element to be disengaged from the recess.

13. The propulsion system of claim 10, wherein:
the second transmission link is configured to be oriented generally parallel to an arm forming part of an airframe of the UAV; and
the second transmission link is configured to be:
mounted within an interior region of the arm; or
attached to an exterior region of the arm.

14. The propulsion system of claim 1, wherein:
the at least a portion of the engagement member is a disk element, the disk element being carried by an elongated rod element and having one or more flange elements positioned to engage one or more corresponding recesses in the propeller when the disk element is in the engaged position;
the elongated rod element is positioned to move along the rotational axis of the motor and to rotate about the rotational axis to cause the disk element to move axially and rotate between the engaged position and the disengaged position; and
when the disk element is in the disengaged position, the one or more flange elements are disengaged from the recesses.

15. The propulsion system of claim 1, further comprising a locking structure positioned to move between a locked position in which the locking structure is engaged with the engagement member, and an unlocked position in which the locking structure is disengaged from the engagement member.

16. The propulsion system of claim 15, wherein the locking structure comprises an elongated arm and a linear actuator positioned to extend and retract the elongated arm.

17. The propulsion system of claim 1, further comprising a sensor assembly positioned to sense whether the portion of the engagement member is in the engaged position, the sensor assembly comprising at least one of a touch switch or a proximity sensor.

18. The propulsion system of claim 17, further comprising a controller programmed with instructions that, when executed:
receive a signal from the sensor assembly indicating whether the portion of the engagement member is in the engaged position; and
transmit a status of the propulsion system corresponding to the signal.

19. The propulsion system of claim 18, wherein the controller is further programmed with an instruction that, when executed, prevents operation of the propulsion motor when the sensor assembly indicates the portion of the engagement member is not in the engaged position.

20. An unmanned aerial vehicle (UAV), the UAV comprising:
an airframe; and
one or more propulsion systems each comprising:
a propulsion motor configured to drive a propeller; and
an apparatus configured to releasably couple the propeller to the propulsion motor, the apparatus comprising an engagement member, at least a portion of the engagement member being positioned to move relative to the propulsion motor and/or the propeller along a rotational axis of the propulsion motor between an engaged position in which the engagement member couples the propeller to the propulsion motor and a disengaged position different from the engaged position;
wherein the propulsion motor is coupled to the airframe and the engagement member is carried by the airframe.
